(19) United States
(12) Patent Application Publication
(10) Pub. No.: US 2008/0151951 A1
(43) Pub. Date: Jun. 26, 2008

(54) Laser optical system

(76) Inventors: David J. Elliott, Wayland, MA (US); Kenneth J. Harte, Carlisle, MA (US); Ronald P. Millman, Taunton, MA (US); Victoria M. Chaplick, Webster, MA (US)

Correspondence Address: MILLS & ONELLO LLP, ELEVEN BEACON STREET, SUITE 605, BOSTON, MA, 02108, US

(21) Appl. No.: 11/644,817

(22) Filed: Dec. 22, 2006

(51) Int. Cl. H01S 3/10

(52) U.S. Cl. 372/24

(57) ABSTRACT

A compact optical system is provided for delivering laser radiation with high optical efficiency and uniformity. The optical system includes, in order of the propagation of light, a refractive beam expander to adjust beam size and energy density, a beam flattening module to increase throughput and beam uniformity, an anamorphic corrector to equalize ray distribution in both axes, an attenuator assembly to adjust beam intensity, galvanometer mirrors to scan the beam across a substrate surface, and a focusing lens containing a plurality of refractive elements to deliver the beam at the substrate plane. The laser optical system shapes the laser source beam to increase its effective width for greater productivity in manufacturing, and reduces peak intensity to minimize substrate damage. The laser optical system design is optimized for maximum transmission and optical efficiency for low cost operation with a small laser.

### FIELD OF THE INVENTION

The present invention relates generally to an optical system apparatus using laser light, and more specifically, a scanning laser apparatus and method for annealing, curing and imaging of semiconductor films or optical devices.

### BACKGROUND OF THE INVENTION

The rapid increase in integrated circuit complexity, with circuit density doubling roughly every two years (following Gordon Moore's Law), has resulted in the use of thinner, easily damaged films. New high-speed thin oxides, called ‘low-k films,” are very easily damaged by conventional annealing, imaging and curing systems. Currently, these functions are performed with large-footprint, complex and high-cost tools. The increasing cost of energy also generates a need for more energy efficient radiation sources used to anneal, image, and cure coatings on semiconductor films in IC production process. There is therefore a need for a simple, low-cost-of-ownership, and energy efficient laser optical system that can be used directly on silicon wafers and optical device substrates for a number of surface reactions, including photo-imaging, photo-curing, and annealing. There is a further need for a compact, low-cost optical system with high transmission efficiency that can be used for annealing, imaging, curing and other applications in semiconductor processing.

Annealing of films in semiconductor manufacturing is widely used for re-structuring the surface by heating the surface, followed by cooling. Annealing is used for many purposes, including repairing surface damage from ion implantation, reducing stresses in a film, improving surface reflectivity or reducing roughness, changing internal properties such as grain size, reducing brittleness, or increasing strength or toughness of a film. There are many possible improvements brought about by annealing through the application of uniform laser radiation of various wavelengths to the surface of a film.

Annealing is typically performed in a high-temperature electric furnace at about 900-1100 degrees centigrade in a dry nitrogen ambient for 30-45 minutes depending on the sample being processed. The main problems with electric furnace anneals are excessive time to process, which limits productivity, and excessive heat. The excessive thermal heating of the wafer causes it to warp. Heating of the bulk thickness of the wafer also causes the ions inside the crystal lattice of the silicon wafer to be redistributed, usually deeper, thereby unfavorably changing the electrical properties of the device. Electric furnaces also cannot be kept sufficiently clean during this process, and contaminants deposit on the wafer surface during the process, causing defective devices.

In laser annealing, large lasers are typically used. These large lasers produce significant heat in the substrate and cause problems by thermally deforming the substrate. The high power of these lasers, along with the heat they produce, results in a complex laser optical system that has a large footprint and that may require cooling. The overall size, complexity, and cost of current annealing systems are a problem for semiconductor manufacturers.

Laser optical systems are also used in photo-imaging applications. These systems are generally very large-footprint, complex optical systems with relatively high cost of ownership, and are typically limited to a single application. Many such systems move the substrate under a fixed beam in order to address the entire wafer substrate, limiting their throughput by using a step-and-repeat motion with focusing at each step. There are also laser scanning optical systems, but these also have very large footprints and require costly and complex optics. Further, many imaging laser optical systems use short ultraviolet (uv) wavelengths, which have high optical losses and require expensive, high-purity optical materials. For example, optical losses of 50% are not unusual in applications requiring the use of uv lasers such as excimer lasers.

In curing applications in integrated circuit (IC) processing, lamps and ovens are used to supply energy. Traditional thermal curing in ovens requires high temperatures of up to 400 degrees C. Such a high temperature can damage many devices. Lamps used for curing also generate considerable heat and are not able to provide the high degree of uniformity needed in IC processing.

### SUMMARY OF THE INVENTION

The present invention was made in light of the above needs and problems, and is directed to an apparatus and method for laser exposure on a surface. Accordingly, it is an exemplified feature of the present invention to provide a laser optical system and method that is simple in design, compact in size, reliable in operation, and with a low cost of ownership. It is a further feature of the invention to provide a laser optical system that can be configured into multiple optical configurations to permit operation at multiple wavelengths and processing of different applications with a single system. It is still another feature of the invention to precisely deposit laser radiation uniformly on the surface of the substrate, and create a reaction without depositing high thermal energy into the bulk of the film. Another feature of the invention is to provide a low pulse energy system with the ability to spread the laser energy sufficiently to permit the processing of damage sensitive films. Finally, it is a feature of the invention to provide relatively high productivity measured in substrates per hour.

In the present invention, in order to achieve such features, the laser optical system is equipped with a small, solid-state laser and compact, folded modular optical system that provides relatively constant output for prolonged periods without requiring maintenance or adjustment. The laser can further provide a wide range of useful wavelengths, from ultraviolet through the visible and into the infrared, by exchange of a pre-aligned optical module. Prior art imaging, curing and annealing systems for semiconductor manufacturing may use large gas lasers, such as excimer lasers, that require frequent gas change, optics change, and have high maintenance costs with frequent down times that limit productivity.

According to one aspect, the invention is directed to a laser optical system. The system includes a laser source for generating a beam of radiation along a path. An optical expander provides variable expansion of the beam in the path. A scan mirror scans the beam onto a substrate in a first dimension. A scan lens images the beam onto the substrate.

In one embodiment, the laser optical system further includes a second scan mirror for scanning the beam onto the substrate, such that the beam can be scanned onto the substrate in the first and a second dimension.

In one embodiment, the laser optical system further includes an anamorphic corrector for changing a beam divergence in one axis to permit the same divergence and effective source point in the first and a second axis.

In one embodiment, the optical expander has a variable expansion factor and is focusable.

In one embodiment, the laser optical system further includes a flattener for flattening the beam. The flattener can include spherical lenses, and, in one particular embodiment, can include two plano-convex lenses.

In one embodiment, the laser optical system further includes a window between the scan mirror and the substrate. The window can have sufficient optical power to preferentially change an incident angle of the beam where it lands on the substrate, such that an incident angle at a substrate surface plane is the same across the substrate. The window can include quartz. The window, the substrate and a volume between them can be enclosed to permit a positive or negative pressure environment with gas flow between the window and the substrate. The volume between the window and the substrate can be purged with a laminar gas flow. The volume between the window and the substrate is under positive pressure. The volume between the window and the substrate is under negative pressure. The volume between the window and the substrate is at atmospheric pressure.

In one embodiment, the laser optical system further includes a mounting plate to which components of the laser optical system are mounted, the mounting plate being vibration isolated and the components being pinned in place on the mounting plate for self-alignment and ease of replacement.

In one embodiment, the laser source comprises a solid-state laser. In one embodiment, the laser source comprises a diode-pumped laser. In one embodiment, the laser source comprises a flash-lamp-pumped laser. In one embodiment, the laser source comprises a YAG laser. In one embodiment, the laser source comprises a frequency-tripled YAG laser operating at a wavelength of 355 nm.

In one embodiment, the laser source comprises a laser operating at a wavelength in a range of 190 to 1070 nm. In one embodiment, the laser source comprises a laser operating at a wavelength in a range of 150 to 550 nm. In one embodiment, pulse energy of the laser source is less than one mJ. In one embodiment, pulse energy of the laser source is in a range of 0.1 to 1.5 mJ. In one embodiment, the laser source comprises a pulsed laser with a pulse repetition rate in range of 10 to 100 kHz.

In one embodiment, the optical expander has a range of 0.5 to 5.0 in magnification. In one embodiment, refractive elements in the optical path comprise fused silica. In one embodiment, the scan lens is an f-theta lens

### BRIEF DESCRIPTION OF THE DRAWINGS

The foregoing and other features and advantages of the invention will be apparent from the following more particular description of preferred embodiments of the invention as illustrated in the accompanying drawings, in which like reference characters refer to the same parts throughout the different views. The drawings are not necessarily to scale, emphasis instead being placed upon illustrating the principles of the invention.

FIG. 1 is a schematic view of an optical system in accordance with one embodiment of the invention.

FIG. 2 is a detailed schematic diagram of the optical system of FIG. 1, including imaging optics, according to an embodiment of the invention.

FIGS. 3A through 3C contain a ray diagram of one embodiment of the laser optical system of the invention.

FIG. 4 is an isometric view of a laser optical system according to an embodiment of the invention.

### DETAILED DESCRIPTION OF THE PREFERRED EMBODIMENTS

In a preferred embodiment, the laser optical system of the present invention is designed to transform a non-uniform beam of Gaussian intensity distribution into a beam of relatively uniform intensity distribution, and with a desired diameter. The uniform intensity permits wider process latitude and process control in manufacturing. This is especially useful in advanced semiconductor manufacturing. The controlled diameter beam permits optimum processing with higher throughput for cost effective manufacturing.

In the present invention, in order to achieve high uniformity of the reaction on the substrate, a beam flattener is used that removes the high intensity peak of the laser's Gaussian output beam, and re-directs the rays into a uniform distribution at the substrate plane. Further, a beam scanning, pulse-distribution approach is used that deposits the laser pulses apart from each other in both time and space dimensions, so that in a given area of the substrate, only single pulses are deposited, and each pulse is typically less than 2 mJ, and, in a particular exemplary embodiment, between 0.1 and 1.5 mJ, in intensity. This feature of the present invention permits the use of the invention for laser exposure of the most delicate semiconductor films without causing damage. Combined with the use of longer near-visible and visible laser radiation, there is no significant heat deposited into the bulk of the substrate.

In the present invention, in order to achieve a small footprint, the optical system is folded several times, with functional modules placed between the beam turning mirrors. This allows the entire optical system, including the laser source, to be placed on a single platform that is approximately 4.5 square feet. The platform vibration is isolated from the rest of the system by vibration-isolated mounts beneath the main mounting plate.

In the present invention, in order to perform in multiple applications including imaging, annealing and curing for example, the optical system is designed into discrete optical modules, each performing a specific function. Optical modules that can be easily exchanged are pre-aligned with the use of pins in the mounting plate, allow the laser optical system of the invention to be used in multiple applications, eliminating the need to purchase separate systems for each dedicated application.

In the present invention, furthermore, an intensity adjustment optical module, including two beam-splitter mirrors fixed at opposite 45 degree angles to each other is provided. It would also be possible, since the optical modules are all positioned at the same height, to install a laser metrology device to track the output of the optical system at any point along the beam path.

Alternatively, the operator may insert the laser metrology device at any point in the beam path for a quick measurement of laser output, either beam shape or beam intensity.

In a particular embodiment of the invention, the beam is programmed to move at a particular scan speed, with a particular spacing of pulses, and at a particular pre-determined laser pulse repetition rate or shots-per-second, to allow the precise deposition of laser radiation at the substrate. The laser beam diameter d at the substrate is first set to a desired value, typically between 0.15 mm and 1.5 mm. Then the laser pulse repetition rate R is selected to give the desired fluence F=4P/(πd²R), where P=laser power at the substrate. Finally, pulse spacing s is chosen, which determines the scan speed v=sR, for precise deposition of laser radiation at the substrate. The purpose of this is to optimize the dose and fluence levels on the surface of the substrate or film, a key control parameter especially useful for photo-crosslinking or photoimaging of polymer films. This pulse-deposition approach is also highly useful to control the precise amount of heat deposited on a surface, a key variable in annealing applications. The pulse-deposition algorithm is a stored computer program in the system.

In many prior art laser optical systems, it is not unusual to spend considerable time aligning and measuring the beam before production can be run. In one aspect of the invention, each optical module is pinned to the main optics plate to provide a self-aligning optical path. A relatively quick alignment check is made by minor adjustments to the gimbal mounts holding each optical module.

In another embodiment of the invention, by changing the distance between the scan lens and the substrate plane, the entire system can be readily scaled to expose larger or smaller substrates without changes to the laser. This eliminates the need to use a larger system to accommodate larger substrates. In an embodiment of the present invention, the optics plate may be raised relative to the substrate plane, or the substrate plane may be lowered relative to the optics plate to achieve the same effect. A scanning beam on a substrate may land at the edges of the substrate at a nine degree angle. Raising the optics platform relative to the substrate plane will reduce this incident angle by some amount, permitting the light to penetrate small features on the substrate. In a further embodiment of the invention, the laser and optics platform is raised sufficiently above the substrate plane so as to become near-telecentric. In another embodiment, the window above the substrate plane is made to provide optical power, so as to change the incident angle of the light landing on the substrate.

The present invention relates generally to an optical system apparatus using laser light, and more specifically, a scanning laser apparatus and method for annealing and imaging of semiconductor films or optical devices. In particular, the invention relates to annealing films of silicon, as well as annealing to change physical properties in metal and non-metal thin films used in semiconductor manufacturing. The invention also relates to an optical system and method for imaging directly with a laser beam into photo-curable films to create MEMS devices or generate images for subsequent etching to fabricate semiconductor or optical devices. The invention features a compact and low cost of ownership apparatus and method. The invention is useful therefore for high speed, low-cost annealing of substrates and exposure of films used in the manufacturing of integrated circuits, thin-film heads, optical devices, MEMS, and the like.

In accordance with one aspect of the invention, there is provided a laser optical system that is compact, uses laser pulses of less than two mJ and, in a particular exemplary embodiment, between 0.1 and 1.5 mJ that does not generate significant heat in the bulk of the substrate, and has high optical efficiency to reduce cost. In a preferred embodiment of the invention, the laser pulses are distributed by a programmable scanning algorithm that distributes the pulses in a way that eliminates damage to the surface, evenly distributes the heat energy that is deposited, and has rapid cycle times for high productivity.

In accordance with one aspect of the invention, there is provided a laser optical system for imaging that is smaller, cheaper, has high optical efficiency, and consumes less energy and footprint than prior art laser optical imaging systems.

The present invention also has applications for curing various films. In accordance with one embodiment of the present invention, the beam is used to photo-crosslink an epoxy film layer used in the manufacturing of MEMS devices. In this application, the beam causes the film to form an isolated, fully-hardened shape that becomes the final part of a MEMS device, with no further process step. In curing applications such as these, prior art practice is to use large ovens, large infrared panels, or large banks of lamps to provide the necessary heat and curing radiation. These systems add considerable heat to the entire substrate, which is not only inefficient, but also may warp and damage the substrate in the process of curing surface films. The high and rising cost of clean room fabrication facilities in semiconductor manufacturing makes large systems expensive to use. Laser optical systems are also used for curing, but are generally large footprint tools with complex and expensive optics, and a relatively large laser with high pulse energies that transfer considerable heat into the bulk of the substrate and have the problem of not controlling the deposition of energy to a particular depth in the film.

In a particular embodiment of the invention, a small footprint, optically-folded laser curing system is provided that does not heat the bulk of the substrate, and can be controlled to deposit precisely controlled amounts of radiation for curing such that the degree of curing can be readily repeated and accurately maintained to a particular depth of the film being cured. This is possible because of the use of longer wavelength radiation than prior art systems, and the use of a laser pulse with less than two mJ and, in a particular exemplary embodiment, between 0.1 and 1.5 mJ, of energy. Even with high pulse repetition rates, the laser pulses of the present invention are spread out by using a pulse distribution approach so heat never builds up in the bulk of the film.

Another feature of the present invention is the use of interchangeable optical modules, permitting a wide range of beam sizes and intensities within the same system with only minor and simple module exchanges. Prior art systems are generally dedicated to a single application, and are not modular or adaptable to multiple applications. In a preferred embodiment, the laser optical system of the present invention provides optical modules for expanding and shaping the beam to permit a wide variety of beam sizes and configurations so many different applications can be processed with the same system.

Several prior art imaging, annealing and film curing methods, frequently based on the use of uv laser light, are limited because of the need for large and unreliable excimer or similar large wattage and footprint laser sources, and the dependence on expensive uv optics that damage easily because of the high photon energy (6.4 eV) of uv photons. The laser of the present invention is a small footprint solid-state laser with low energy (3.42 eV) photons. At the longer wavelengths, optics lifetimes are extended due to less absorption in the lenses, and much less scattering and loss of energy, permitting a highly efficient system.

Therefore, the invention provides a small-footprint, compact laser optical system that is compact in size, with high reliability and energy efficiency, providing a low cost of ownership. The invention also provides a laser optical system that can deposit laser radiation with a high degree of uniformity and control, without depositing significant heat in the bulk of the substrate. The invention also provides a laser optical system that has high throughput, for high productivity in production. The invention also provides a laser optical system that can be used for multiple semiconductor applications, eliminating the need for multiple tools.

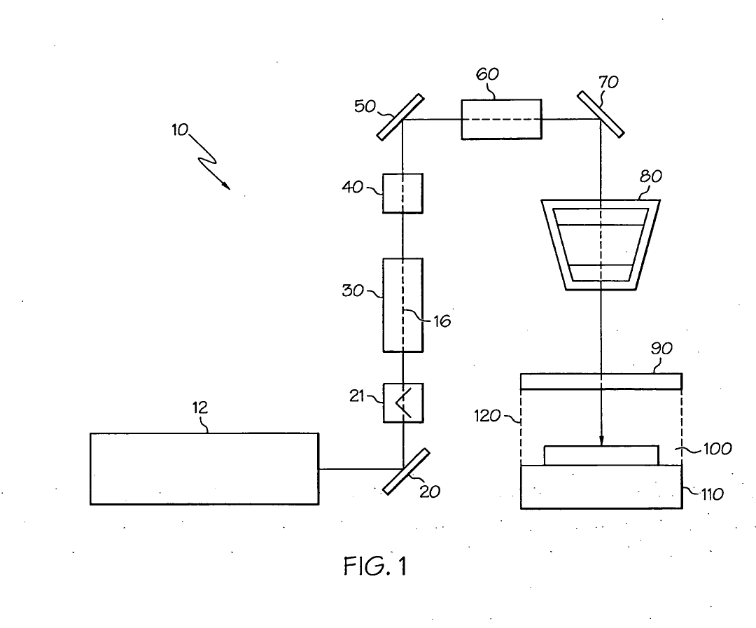

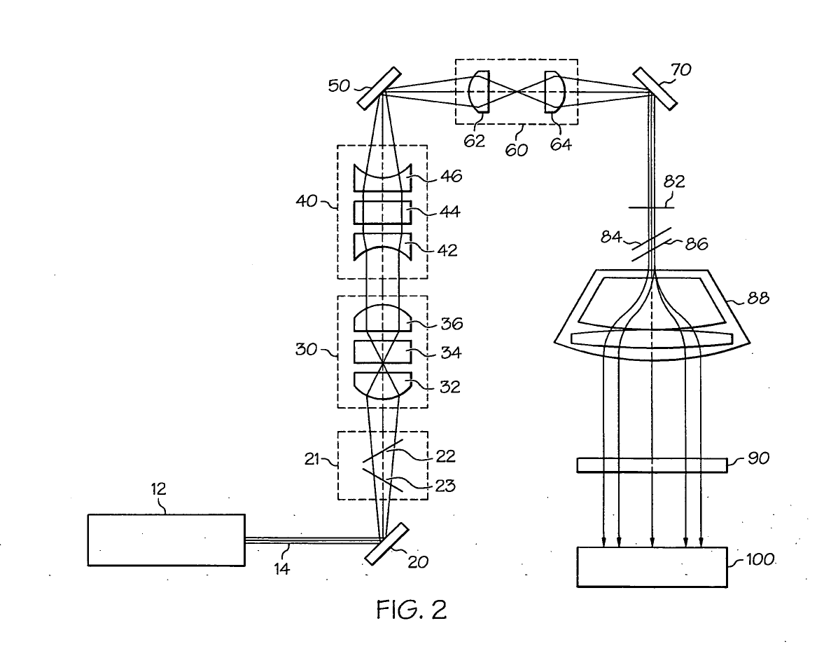

The laser optical system embodying the invention will be described with reference to the drawings. FIG. 1 is a schematic diagram of one embodiment of the optical system of the invention, and FIG. 2 is a detailed schematic diagram of the optical system of FIG. 1, including imaging optics, according to an embodiment of the invention. Referring to FIGS. 1 and 2, the optical system 10 includes a radiation source 12, for example, a ten-watt solid state laser 12, that generates primarily near-visible 355 nm wavelength radiation along with residual visible 532 nm wavelength radiation in a beam 14 along the optical axis 16. The laser source 12 can be a diode-pumped or flash-lamp-pumped solid-state YAG laser or other similar laser. In one particular embodiment, the laser source is a frequency-tripled YAG laser operating at a wavelength of 355nm. The laser source 12 can be, for example, model number Q301-HD, provided by Lightwave Electronics of Mountain View, Calif., or other similar laser source. The primary beam may also be a wavelength of 266 nm, 532 nm, or 1064 nm, with or without residual radiation of another wavelength. It should be noted that the wavelengths of the radiation are examples only.

The optical system 10 also includes, disposed along optical axis 16, a wavelength-separating beam splitter mirror 20 which preferentially transmits one of the two wavelengths radiating from laser source 12. In an alternative embodiment, mirror 20 is a maximum-reflectance, dielectric-stack coated mirror designed to transmit both the 355 nm wavelength near-visible (or near-uv) radiation as well as the 532 nm visible radiation.

The optical system 10 also includes an anamorphic correction assembly sub-system 30 used to provide compensation for beam divergence in one axis, so as to correct laser beam asymmetry to provide the same beam waist location and divergence angle in both axes. The anamorphic correction assembly includes, in one embodiment, cylinder lenses 32, 34, and 36. The beam from the anamorphic correction assembly 30 enters a variable expander optical sub-system 40, which reduces the energy density downstream and also controls beam divergence. The variable expander optical sub-system 40 can be a model number ZBE20-1X5-355, provided by Photonic Devices, Inc. of Wyckoff, N.J., or other similar device. The variable expander optical sub-system 40 includes, in one embodiment, three spherical (concave, convex, concave meniscus) lenses 42, 44, 46 with a magnification range of, for example, 1.0-5.0x, and can be reversed for performing de-magnification in a range of, for example, 1-0.2x.

The beam is then reflected across the surface of mirror 50 at a 90 degree angle and is transmitted through a beam flattening optical sub-system 60, which flattens the beam to increase uniformity by reducing the maximum-to-minimum intensity variations. The beam flattening optical sub-system 60 can also be used to further expand the beam. In one embodiment, the beam flattening optical sub-system 60 includes two spherical, such as plano-convex, lenses 62 and 64. The beam is then reflected at a 90 degree angle and further transmitted along optical axis 16 into the scan head optical sub-system assembly 80. The scan head optical sub-system assembly 80 can be a model “hurrySCAN14,” provided by ScanLab AG, of Puchheim, Germany, or other similar device. The beam enters the scan head optical sub-system through the entrance aperture 82 and is directed onto the surface of galvanometer mirror 84 and on to second orthogonal galvanometer mirror 86, from which the beam is scanned across the surface of the first element of the multi-element f-theta scan lens assembly 88. The scan lens assembly 88 can be a model number 106566, provided by ScanLab AG, of Puchheim, Germany, or other similar device. In one embodiment, the scan lens assembly 88 can be a telecentric f-theta lens to provide a beam landing angle at the substrate 100 of less than 6 degrees.

The function of scan lens 88 is to focus the beam, while passing through a quartz chamber window 90 onto the substrate plane 100. The substrate sits on a substrate holder 1 10, and the area between the quartz window 90 and substrate holder 110 can be enclosed with enclosure 120.

The modules in the optical path are designed with a minimum number of simple preferably fused silica elements for maximum laser energy efficiency, permitting cost effective use of a small laser in manufacturing applications. The optical path is further turned or folded three times so that any misalignment of the laser 12 can be readily compensated by adjustment of mirrors 20, 50, or 70 so that the beam is aligned on the optical axis when it reaches the substrate.

Referring to FIG. 1, the space between the window 90 and the substrate 100 can be controlled with different ambients and pressures without the use of a vacuum chamber or other costly structure for the primary applications of annealing, curing and imaging. In annealing applications, it may be useful to provide a gentle flow of an inert cooling gas, such as helium or argon, between the window and the substrate. Nitrogen may also be used, and any of these gases can be introduced into the space between elements 90 and 100. A simple flexible plastic curtain or other shielding material 120 can be used for this purpose without needing to construct a costly chamber with attending vacuum pump and plumbing. This allows the application to be performed with minimum cost and complexity, the optical system 10 being the primary functional requirement.

In curing applications, gaseous by-products may be given off during the laser exposure of the material being cured. As in the case for annealing, a slow flow of an inert gas may be used to carry off the gaseous by product, under slight positive pressure of 1-5 psi for example. Any pressure over atmospheric pressure can be used, but lower pressures are preferred for safety and cost reasons.

In imaging applications, the environment between window 90 and substrate 100 can be purged with a gas at slight positive or negative pressure to prevent airborne molecular contaminants such as amines from landing onto the substrate 100 and causing cross-linking, such as with chemically amplified photoresists. Some polymers being imaged, such as positive-working photoresist based on Novolak polymers with diazo-sensitizer systems, will evolve nitrogen during laser exposure. This small amount of nitrogen can be vented off by the flow of an inert gas such as argon. In imaging, slight positive pressure in the space between the quartz protective window 90 and the substrate 100 will keep solid airborne particle contaminants from getting between the beam and the material being exposed. The main function of the gas purging in this case is to keep contamination from entering this area and interfering with laser exposure of the substrate. Gas purging the area between the window and substrate is especially useful when the system is used to remove polymer coatings.

In all of the cases discussed above, it is not necessary to fully enclose the substrate with a chamber and vacuum system. The use of a shield 120 and slight gas flow with positive or negative pressure will allow the removal of heat or particles.

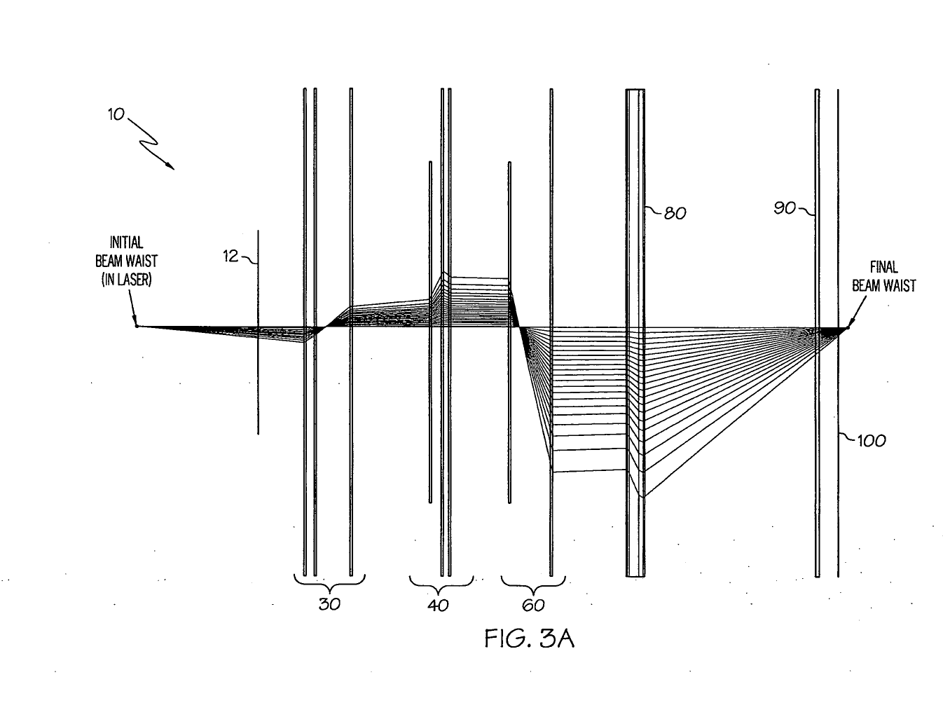

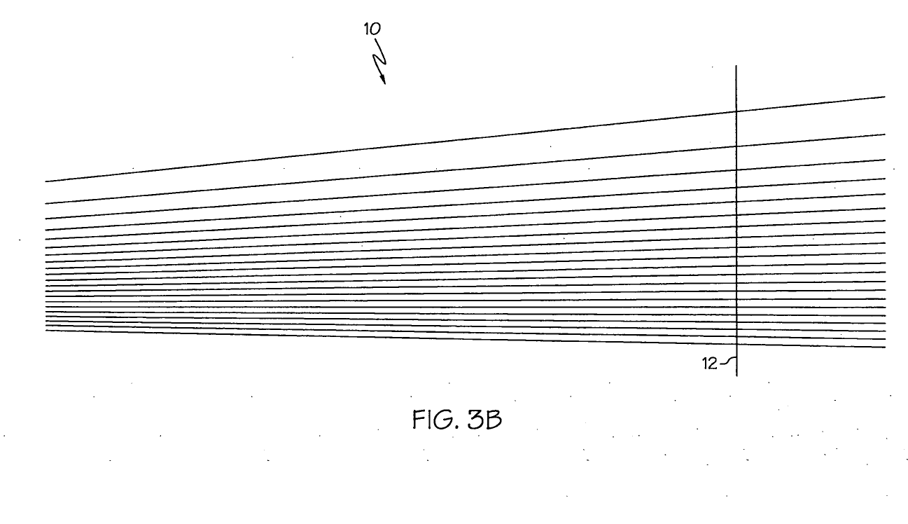

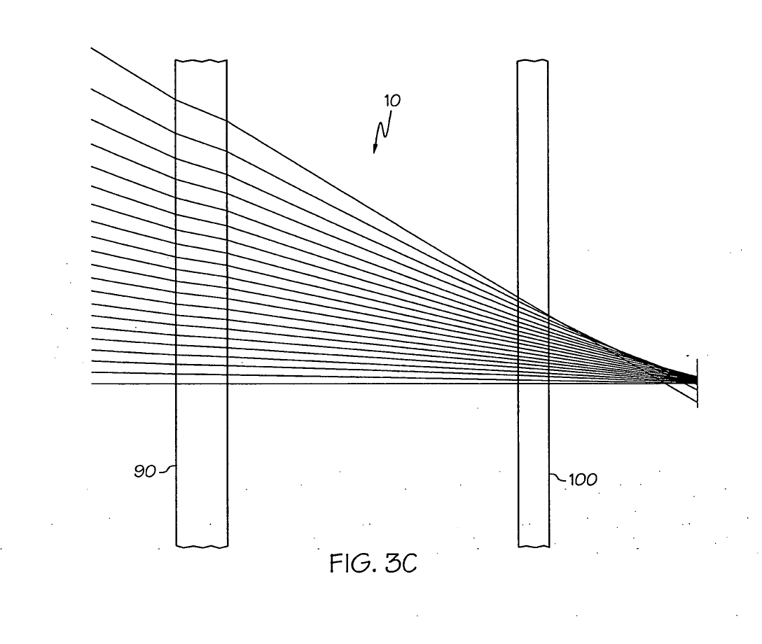

FIG. 3A is a ray diagram of the optical system 10 of FIGS. 1 and 2. Referring to FIGS. 1, 2 and 3A, the laser beam ray distribution is shown beginning at the exit of the laser source 12, indicated by reference numeral 14, and moving down the central axis of the optical path 16 through the components of the optical system 10 to the work plane 100. FIGS. 3B and 3C are more detailed ray diagrams illustrating the rays at the beginning and end of the optical path 16. Specifically, FIG. 3B illustrates the rays at the exit of the laser 12 and at the plane of the wafer 100, after the rays have passed through the optical system 10 of the invention. Referring to FIGS. 3A through 3B, the beam rays at the laser exit are unevenly spaced, while the rays at the wafer plane are very evenly spaced, to provide uniform photon energy density for a variety of laser reactions on surfaces. In semiconductor processing, it is important to provide highly uniform radiation. Many prior art optical systems achieve uniformity by using beam homogenizers or apertures, optical devices that may cause significant loss of beam energy. In a preferred embodiment, the present invention provides substrate plane uniformity without the use of a beam homogenizer or beam limiting aperture, which results in high optical transmission and minimal loss of laser beam energy.

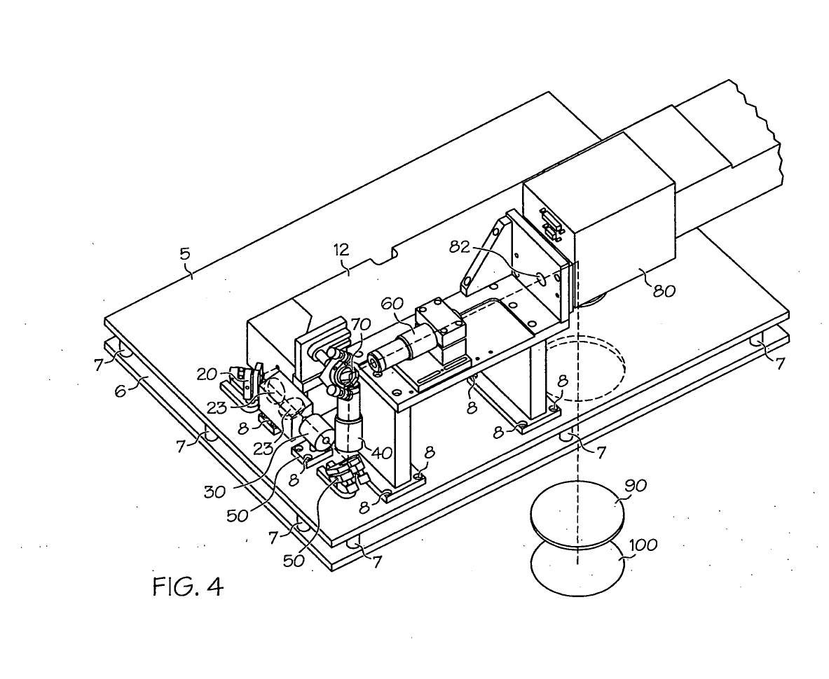

FIG. 4 is an isometric view of a laser optical system 10 according to an embodiment of the invention. The configuration of FIG. 4, while slightly different than that of the embodiment illustrated in the schematic diagrams of FIGS. 1 and 2, is applicable to the embodiment of FIGS. 1 and 2.

Referring to FIGS. 1, 2 and 4, the optical system 10 is shown mounted on the main optics plate 5. The system 10 provides a uniform ‘top hat’ energy distribution, as described above with reference to FIGS. 3A through 3C. In a preferred embodiment of the invention, the beam shape is circular, but an elliptical beam may be formed if desired for a particular application. Beam size depends on the application, particularly the desired fluence, which is inversely proportional to the square of the beam size. In a preferred embodiment, the beam size is selectable over a range of 0.15 to 1.5 mm by adjustment of the beam expander 40 and beam flattener 60.

In the embodiment of FIG. 4, mirror 50 has been inserted just after the anamorphic corrector module 30, and the beam expander 40 is mounted vertically. This sequence is not critical and may be varied, as is shown in FIG. 1 and FIG. 2.

The bending mirrors 20, 50, and 70 are provided to fold the beam and thereby create a compact optical system, and to facilitate easier alignment. The mirrors are coated with a high reflectivity dielectric coating for maximum reflection at the operating wavelength. In a preferred embodiment of the laser optical system, each of the three mirrors bends the beam 90 degrees about mutually orthogonal axes. The mirrors are made of uv-grade fused silica, and the coatings on top of the substrate are designed to provide 99% or higher reflectivity at a 45 degree angle of incidence. The mount for each mirror, in a preferred embodiment, has three adjustments to align the beam, namely, a) rotation about an axis in the mirror plane perpendicular to the incoming beam; b) rotation about an axis in the mirror plane at 45 degrees to the incoming beam, and c) displacement along the incoming beam.

As shown in FIGS. 1, 2 and 4, the system 10 of the invention may also include an optional attenuator 21. The attenuator 21 includes two beam splitters 22 and 23. The function of the attenuator 21 is to reduce the beam energy reaching the substrate when the desired fluence is less than can be obtained by increasing the laser repetition rate and the beam size. Attenuators can be implemented by using one or more beam splitters 22 and 23, or using one or more neutral density filters. In a preferred embodiment of the invention, two 45 degree beam-splitting mirrors 22 and 23 of the same thickness are placed in the beam path, one rotated +45 degrees about an axis perpendicular to the beam, the other rotated 45 degrees about the same axis. In a particular configuration, the displacement of the beam from the optical axis caused by the two beam-splitters 22, 23 is equal and opposite, and therefore cancels out.

The anamorphic corrector 30 is used to correct circular asymmetry of the beam shape, or divergence angle, or both. This module includes two or more cylindrical lenses oriented in the same direction. In a preferred embodiment of the invention, three convergent lenses 32, 34, 36 are used to comprise the anamorphic corrector 30. The middle, weaker lens 34 is used as an adjustment to make the beam circular or elliptical as needed. The entire assembly is ideally held in a gimbal mount with four degrees of freedom, those being tilt, pitch, and two orthogonal axes of displacement perpendicular to the optical axis.

The beam expander 40 provides a collimated input beam of appropriate diameter for the beam flattener 60. In a preferred embodiment, the beam expander includes three lenses 42, 44, 46. The second and third lenses 44, 46 are individually adjustable relative to the first lens 42 to select the expansion factor and focus the beam. The beam expansion factor of this module is, in a preferred embodiment, variable from 1.0 to 5.0x. By reversing the beam expander 40 position 180 degrees, the module becomes a beam reducer, providing reductions down to 0.2x of the normal beam size at 1x.

The beam flattener 60 is used to transform the Gaussian or nearly-Gaussian laser beam into a flat-topped beam at the image or substrate plane, not at the focal plane of the f-theta scan lens 88. The beam flattener 60 introduces positive spherical aberration into the beam that alters the ray distribution in that image plane so that rays further from the axis, being the tails of the original Gaussian distribution, are bent toward the axis such that the distribution becomes approximately flat-topped. In a preferred embodiment of the invention, the beam flattener 60 includes two convergent lenses 62 and 64. The lens 62 is a strong lens (f=27 mm) and the lens 64 is a weak lens (f=90 mm). The distance between the lenses 62, 64, which in one embodiment is 117 mm, is adjustable for focusing the device. This implementation expands the beam by a factor of, for example, 10/3, and flattens the beam. The beam flattener 60 is preferably held in the same type of gimbal mount with four axes of freedom. In an alternative embodiment, a third, weakly convergent lens can be added to the flattener 60 so that the expansion ratio can be varied, with a fixed expander preceding it, or with a possible fourth lens to control collimation, thus eliminating the need for a separate expander altogether.

The scanning mirrors 84 and 86 deflect the beam across the surfaces and through the scan lens 88. In the preferred embodiment, as shown in FIG. 2, two scan mirrors are used to achieve two dimensional scanning so that the wafer can be stationary. In another embodiment, the scanning may be one dimensional, with substrate coverage achieved by stage motion rather than a moving beam. The scan lens module 80 contains the mirrors, which are held on galvanometer-type mounts to provide high speed motion. The scan lens is of the f-theta type, highly corrected to provide linear scanning and flat-field imaging. Deflection iso-centers are preferably close to the back focal plane of the f-theta lens resulting in near-telecentric imaging. In a preferred embodiment, the scan lens covers a 200 mm circular or 150 mm square field of view with a maximum residual non-telecentricity of six degrees. In one embodiment, the window 90 has sufficient optical power to preferentially change the incident angle of the beam where it lands on the substrate surface, such that the incident angle at the substrate surface plane is the same across the diameter of the substrate.

The typical performance achieved with the preferred embodiment of the system is a 94% fit to top-hat distribution with a 0.50 mm diameter beam over a 150 mm square field. Beam circularity is better than 5%. Maximum fluence with that beam size is 600 mJ/cm² at 10,000 pulses-per-second laser repetition rate. In a preferred embodiment, a 16-pass interleaved pulsing algorithm is used with 50% beam overlap between adjacent pulses and a scanning speed of 10 m/s to treat the surface of a substrate. The approximate process time for a single 200 mm silicon wafer is between 97 seconds and 124 seconds depending on the scan program.

Referring to FIG. 4, the optical system 10 can be mounted on the optical plate 5, which is mounted to a base plate 6 in a vibration isolated fashion to prevent vibration from adversely affecting performance of the optical system. The vibration isolation is achieved through the use of multiple vibration isolation grommets 7 between the optical plate 5 and the base plate 6. The grommets 7 eliminate vibration and torsion in the optical system 10. The optical modules of the system 10 are mounted using pins 8 to secure them to the optical plate 5. Pinning the modules to the plate 5 permits the same position for a module to be achieved each time the modules are removed and/or replaced.

Specific values for the optical components of the system of the invention in one particular preferred embodiment are set out in the following table

| Index | Zvx | Curv | Cx | Tilt | Pitch | Roll | Dx | Dy | F | MLI? | Notes |
|---|---|---|---|---|---|---|---|---|---|---|---|
| 1.0 | −420.000 | 0.00000000 | | | | | 1.0 | | r | Ir 1 | Laser Beam Waist |
| 1.0 | 0.000 | 0.00000000 | | | | | 5.0 | | r | Ir 2 | Laser Exit |
| 1.0 | 78.510 | 0.00000000 | | | −45.0 | | 24.0 | | r | Ir 3 | Mirror M1 |
| 1.0 | 100.000 | 0.03278689 | 0.0 | | | 90.0 | 20.0 | 20.0 | s | Le 4 | Corrector L1 |
| Fused Silica | 106.000 | 0.00000000 | | | | 90.0 | 20.0 | 20.0 | s | Le 5 | Corrector L1 |
| 1.0 | 132.767 | 0.00000000 | | | | 90.0 | 20.0 | 20.0 | s | Le 6 | Corrector L2 |
| Fused Silica | 137.767 | −0.01572327 | 0.0 | | | 90.0 | 20.0 | 20.0 | s | Le 7 | Corrector L2 |
| 1.0 | 235.771 | 0.00000000 | | | | 90.0 | 20.0 | 20.0 | s | Le 8 | Corrector L3 |
| Fused Silica | 240.771 | −0.02624672 | 0.0 | | | 90.0 | 20.0 | 20.0 | s | Le 9 | Corrector L3 |
| 1.0 | 408.740 | 0.00000000 | | 45.0 | | | 24.0 | | r | Ir 10 | Mirror M2 |
| 1.0 | 469.000 | −0.07874000 | | | | | 12.0 | | r | Le 11 | Expander L1 |
| Fused Silica | 473.000 | −0.01398328 | | | | | 12.0 | | r | Le 12 | Expander L1 |
| 1.0 | 502.806 | 0.01152112 | | | | | 24.0 | | r | Le 13 | Expander L2 |
| Fused Silica | 507.806 | −0.02694802 | | | | | 24.0 | | r | Le 14 | Expander L2 |
| 1.0 | 525.620 | 0.03675277 | | | | | 24.0 | | r | Le 15 | Expander L3 |
| Fused Silica | 529.620 | 0.04640984 | | | | | 24.0 | | r | Le 16 | Expander L3 |
| 1.0 | 560.580 | 0.00000000 | | | −45.0 | | 24.0 | | r | Le 17 | Mirror M3 |
| 1.0 | 700.000 | 0.06944400 | | | | | 12.7 | | r | Le 18 | Flattener L1 |
| Fused Silica | 703.950 | 0.00000000 | | | | | 12.7 | | r | Le 19 | Flattener L1 |
| 1.0 | 820.027 | 0.00000000 | | | | | 25.4 | | r | Le 20 | Flattener L2 |
| Fused Silica | 825.627 | −0.02283100 | | | | | 25.4 | | r | Le 21 | Flattener L2 |
| 1.0 | 883.180 | 0.00000000 | | | | | 20.0 | | r | Ir 22 | Scan Head Entr |
| 1.0 | 953.030 | 0.00000000 | | 45.0 | | | 20.0 | | s | Ir 23 | Scan Mirror S1/M4 |
| 1.0 | 968.820 | 0.00000000 | | | −45.0 | | 20.0 | | s | Ir 24 | Scan Mirror S2 |
| 1.0 | 1038.980 | 0.00000000 | | | | | 49.8 | | r | Ir 25 | Scan Lens Top |
| 1.0 | 1042.980 | −0.01225521 | | | | | 40.2 | | r | Le 26 | Scan Lens L1 |
| Fused Silica | 1047.280 | 0.00143183 | | | | | 40.2 | | r | Le 27 | Scan Lens L1 |
| 1.0 | 1048.980 | −0.00403166 | | | | | 40.2 | | r | Le 28 | Scan Lens L2 |
| Fused Silica | 1074.980 | −0.00848533 | | | | | 68.0 | | r | Le 29 | Scan Lens L2 |
| 1.0 | 1074.981 | 0.00188335 | | | | | 77.0 | | r | Le 30 | Scan Lens L3 |
| Fused Silica | 1086.980 | −0.00813076 | | | | | 77.0 | | r | Le 31 | Scan Lens L3 |
| 1.0 | 1091.180 | 0.00000000 | | | | | 95.0 | | r | Ir 32 | Scan Lens Bot |
| 1.0 | 1585.950 | 0.00000000 | | | | | 200.0 | | r | Le 33 | Window Entr |
| Fused Silica | 1595.480 | 0.00000000 | | | | | 200.0 | | r | Le 34 | Window Exit |
| 1.0 | 1649.150 | 0.00000000 | | | | | 152.4 | | s | Ir 35 | Mask |
| 1.0 | 1654.850 | 0.00000000 | | | | | 200.0 | | r | Ir 36 | Wafer |
| 1.0 | 1679.093 | 0.00000000 | | | | | | | r | Ir 37 | Beam Waist w/o Window |
| 1.0 | 1682.167 | 0.00000000 | | | | | | | r | Ir 38 | Beam Waist w/ Window |

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A laser optical system, comprising:
a laser source for generating a beam of radiation along a path;
an optical expander for providing expansion of the beam in the path; a scan mirror for scanning the beam onto a substrate in a first dimension; and
a scan lens for imaging the beam onto the substrate.

2. The laser optical system of claim 1, further comprising a second scan mirror for scanning the beam onto the substrate, such that the beam can be scanned onto the substrate in the first and a second dimension.

3. The laser optical system of claim 1, further comprising an anamorphic corrector for changing a beam divergence in one axis to permit the same divergence and effective source point in the first and a second axis.

4. The laser optical system of claim 1, wherein the optical expander has a variable expansion factor and is focusable.

5. The laser optical system of claim 1, further comprising a flattener for flattening the beam.

6. The laser optical system of claim 5, wherein the flattener comprises spherical lenses.

7. The laser optical system of claim 6 wherein the flattener comprises two plano-convex lenses.

8. The laser optical system of claim 1, further comprising a window between the scan mirror and the substrate.

9. The laser optical system of claim 8, wherein the window has sufficient optical power to preferentially change an incident angle of the beam where it lands on the substrate, such that an incident angle at a substrate surface plane is the same across the substrate.

10. The laser optical system of claim 8, wherein the window comprises quartz.

11. The laser optical system of claim 8, wherein the window, the substrate and a volume between them are enclosed to permit a positive or negative pressure environment with gas flow between the window and the substrate.

12. The laser optical system of claim 8, wherein a volume between the window and the substrate is purged with a laminar gas flow.

13. The laser optical system of claim 8, wherein a volume between the window and the substrate is under positive pressure.

14. The laser optical system of claim 8, wherein a volume between the window and the substrate is under negative pressure.

15. The laser optical system of claim 8, wherein a volume between the window and the substrate is at atmospheric pressure.

16. The laser optical system of claim 1, further comprising a mounting plate to which components of the laser optical system are mounted, the mounting plate being vibration isolated and the components being pinned in place on the mounting plate for self-alignment and ease of replacement.

17. The laser optical system of claim 1, wherein the laser source comprises a solid state laser.

18. The laser optical system of claim 1, wherein the laser source comprises a diode-pumped laser.

19. The laser optical system of claim 1, wherein the laser source comprises a flash-lamp-pumped laser.

20. The laser optical system of claim 1, wherein the laser source comprises a YAG laser.

21. The laser optical system of claim 1, wherein the laser source comprises a frequency-tripled YAG laser operating at a wavelength of 355 nm.

22. The laser optical system of claim 4, wherein the optical expander has a range of 1.0 to 5.0 in magnification.

23. The laser optical system of claim 1, wherein the laser source comprises a laser operating at a wavelength in a range of 190 to 1070 nm.

24. The laser optical system of claim 1, wherein the laser source comprises a laser operating at a wavelength in a range of 150 to 550 nm.

25. The laser optical system of claim 1, wherein pulse energy of the laser source is less than one mJ.

26. The laser optical system of claim 1, wherein pulse energy of the laser source is in a range of 0.1 to 1.5 mJ.

27. The laser optical system of claim 1, wherein the laser source comprises a pulsed laser with a pulse repetition rate in range of 10 to 100 kHz.

28. The laser optical system of claim 1, wherein refractive elements in the optical path comprise fused silica.

29. The laser optical system of claim 1, wherein the scan lens is an f-theta lens.

30. The laser optical system of claim 29, wherein the f-theta lens is telecentric.

31. The laser optical system of claim 1, further comprising an attenuator to control fluence at the substrate.

32. The laser optical system of claim 31, wherein the attenuator comprises two beam-splitting mirrors oriented at opposite 45 degree angles to the beam path in order to eliminate beam displacement.
